(19) United States
(12) Patent Application Publication
(10) Pub. No.: US 2013/0235510 A1
(43) Pub. Date: Sep. 12, 2013

(54) Electrical Panel Adjustable Filler Plate

(71) Applicants: Charles Ridings, Arlington, TX (US); Wade Pence, (US)

(72) Inventors: Charles Ridings, Arlington, TX (US); Wade Pence, (US)

(21) Appl. No.: 13/221,887

(22) Filed: Aug. 30, 2011

(51) Int. Cl. H02B 1/015

(52) U.S. Cl. 361/627

(57) ABSTRACT

The present invention is an electrical panel filler plate with an adjustable length construction, which allows panel grips on the opposite ends of the filler plate to increase the size of the filler plate to fit snugly inside an electrical panel aperture.

### CROSS-REFERENCE TO RELATED APPLICATIONS

None.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF THE MATERIAL ON THE COMPACT DISC

None.

### BACKGROUND OF THE INVENTION

(1) Field of the Invention

The invention addresses the circuit breaker and electrical panel industry.

(2) Description of the Related Art including information disclosed under 37 CFR 1.97 and 1.98

The electrical construction industry has developed boxes and panels that have partially pre-stamped holes to allow for quick assembly of circuit breakers and other equipment onto circuit panels using minimal or no tools, as an electrician can press on the pre-stamped area with a manageable amount of force and then twist the material to be removed, leaving a rough hole of the appropriate size that easily allows switches, circuit breakers, conduit, and other electrical components to be easily mounted on the panel, and some portion of the component to be visible or exist on the reverse side of the panel.

As the configuration of the panel changes and different components are mounted in different ways, an electrical panel can develop an excessive number of unused holes. Panels may be mounted in such a way that users might endanger themselves if left uncovered, leaving a panel owner with the choice of replacing an expensive panel, or covering the panel hole, typically with an impromptu cover, or leaving an unused component on the panel that “fills” a hole.

These existing approaches to filling an unused hole are unsatisfying, as they either a) cost an inordinate amount of money, b) are esthetically displeasing, or c) require unused components to remain present in a panel. The present invention eliminates these shortcomings.

### BRIEF SUMMARY OF THE INVENTION

The invention is an adjustable filler plate constructed with grips that clasp the internal edges of an existing rectangular aperture. The grips are part of a sliding element that, when compressed, allows the grips to fit inside the aperture, but then slide out to fit the dimensions of the hole so the grips hold the plate in place inside the aperture. Because the distance between the grips can be changed to fill varying aperture lengths, a single filler plate can be reused in different-sized holes as the equipment mounted on a panel is changed and unfilled holes result.

### Objects of the Invention

One object of the invention is to provide an inexpensive means for eliminating openings in circuit panels, circuit boxes, and other similar surfaces.

Another object is to provide a reusable product to eliminate the aforementioned openings.

Still another object is to create a product to fit a variety of aperture sizes.

### BRIEF DESCRIPTION OF THE SEVERAL VIEWS OF THE DRAWING(S)

FIG. 1—Top view of one embodiment of the invention.

FIG. 2—Bottom view of one embodiment of the invention.

FIG. 3—Side view of one embodiment of the invention.

### DETAILED DESCRIPTION OF THE INVENTION

According to the present invention, the foregoing objects and other advantages are attainted by an adjustable-length filler plate 11, which would allow a single plate to fit a number of panel openings.

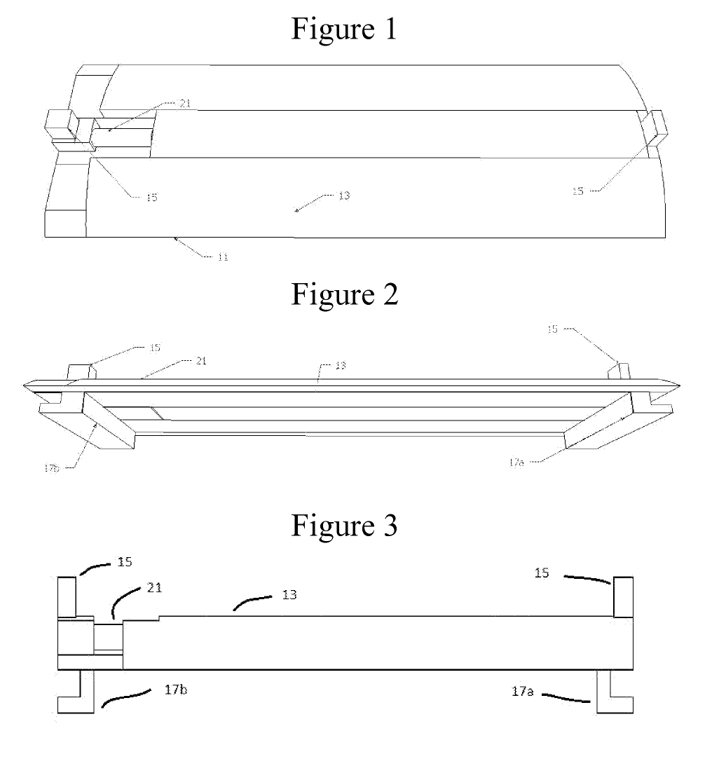

FIG. 1 shows an orthogonal view of the invention 11 in a typical construction with one extension, showing the main body 13, the extension 21 in the closed position, with optional handle projections 15. FIG. 2 is a view of the bottom of the device, and shows panel grip 17a fixed on one end of the main body 19, with another panel grip 17b fixed on the extension 21 in a closed position, such that it grips point in the opposite direction as the main-body panel grip 17a.

FIG. 3 is a side view of an embodiment of the invention, showing the aforementioned with handle grips 15, panel grips 17a 17b and extension 21.

The extension 21 is constructed such that it can be pushed or pulled from the main body 13 to make the assembly 11 physically longer and thus able to cover holes in a panel of varying lengths.

To employ the invention, a user holds the handle projections 15 and maneuvers the main body 13 so that the fixed-end panel grip 17a sits with the panel edge hole in the gripping section, and then, while holding the main body 13 parallel to the panel aperture, pulls on the extension 21 by using the handle projections 15 and guides the extension end panel grip 17b so it engages with the panel on the opposite end as the fixed-end panel grip 17a. In this way, the panel cover is held in place by the two opposite-facing panel grips.

To remove the device and use it elsewhere, a user need only maneuver the handle projections 15 so shorten the length of the device and disengage the panel grips 17a 17b from the panel, allowing the panel cover to be simply lifted away and the device to be used elsewhere.

The extension 21 requires some method of maintaining its length. One method would be a simple construction providing a tight fit between the main body 13 and the extension 21. Another method might include a serrated slide that allows for the extension 21 to slide when sufficient force is applied, but only then.

The device is currently constructed of a plastic mold, but could be constructed of any substance capable of maintaining the shape.

The handle projections 15 are optional, but helpful to maneuver the device. Electrical panels are often in areas where space and movement is limited, so the handles provide a way of easily putting the panel cover in place.

1. (canceled)

2. (canceled)

3. The claimed adjustable filler plate is a two-piece assembly useful for covering rectangular apertures in electrical panels, comprising:
a) a main rectangular body;
b) an extension which lengthens the assembly in one direction, and is attached to the body by a slide, constructed so friction exists between the extension and the body that holds the relative position of the body and extension rigid until and unless a user applies force to overcome the friction and slide the extension to modify the assembly length;
c) a first panel grip formed as a recessed slot in the end of the main body opposite of the extension's direction of expansion;
d) a second panel grip formed as a recessed slot on the opposite side of the assembly on the distal end of the extension, such that the first and second panel grips form a matched pair that can engage the opposite ends of a rectangular opening in an electrical panel and rigidly hold the assembly in place, without additional installed rails, use of any tools, or additional mounting hardware;

4. An apparatus as in claim 3, with additional elements of:
a) a first handle projection extending from the main body in a direction perpendicular to the parallel plane defined by the panel grip recesses;
b) a second handle projection extending from the extension in a direction perpendicular to the parallel plane defined by the panel grip recesses;

5. A method of covering a rectangular opening with an adjustable filler plate, comprising the steps:
a) providing a cover assembly that includes a main rectangular body and an extension, with panel grips on opposite ends of the assembly, one on the main body, and the other on the extension;
b) preparing the assembly by retracting the slideable extension so the assembly is as compact as possible;
c) placing the main body's panel grip into one side of the panel opening;
d) aligning the panel grips so they are in the same plane as the electrical panel into which the assembly is to be mounted;
e) sliding the extension outward until the extension panel grip engages the panel opening on the side that is opposite of the side that the main body panel grip has engaged, such that the entire panel opening is covered.
